(19) United States
(12) Patent Application Publication
(10) Pub. No.: US 2016/0140933 A1
(43) Pub. Date: May 19, 2016

(54) RELATIVE POSITIONING OF DEVICES

(71) Applicant: Empire Technology Development LLC, Wilmington, DE (US)

(72) Inventor: Andrei Pitis, Bucharest (RO)

(21) Appl. No.: 14/768,438

(22) PCT Filed: Apr. 4, 2014
(86) PCT No.: PCT/RO2014/050001

§ 371 Date: Aug. 17, 2015

(51) Int. Cl. G09G 5/12; G06F 3/14; G06F 3/0488; H04L 29/08

(52) U.S. Cl. CPC G09G 5/12; H04L 67/18; G06F 3/1446; G06F 3/04883; G09G 2354/00; G09G 2356/00; G09G 2370/22

(57) ABSTRACT

Technologies are described for positioning a group of devices. In some examples, multiple computing devices may be identified as a proximal set of computing devices. Data indicative of a gesture that spans at least some of the computing devices is received from the proximal set. The relative motion of the gesture is determined with respect to the proximal set. Based on the determined relative motion, the relative spatial positioning of the computing devices in the proximal set is determined.

### BACKGROUND

Users of computing devices may have access to or own multiple computing devices such as tablets, smartphones, and laptops. There may be many situations in which users may want to share data between their devices, or when users are sitting together at a table or in close proximity and would like to interact with one another using their computing devices.

### SUMMARY

In various embodiments, systems, methods, and computer-readable media are disclosed for determining relative positioning of a group of devices. In an embodiment, a plurality of computing devices may be identified as a proximal set of computing devices. Data indicative of a gesture that spans some of the computing devices of the proximal set may be received. A relative motion of the gesture may be determined with respect to the proximal set. Based on the determined relative motion, a relative spatial positioning of the computing devices in the proximal set may be determined.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts an example of determining relative positions of devices using a gesture.

FIG. 2 depicts an example of determining relative positions of devices using a gesture.

FIG. 3 depicts an example of determining relative positions of devices using a gesture.

FIG. 4 illustrates an example o an operational procedure for determining relative positions of devices.

FIG. 5 depicts an example computing environment wherein aspects of the present disclosure can be implemented.

FIG. 6 depicts an example computing environment wherein aspects of the present disclosure can be implemented.

FIG. 7 depicts an example computing environment for practicing aspects of the present disclosure.

FIG. 8 depicts an example computing system wherein aspects of the present disclosure can be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

Many mobile devices implement touchscreen technology and users are provided the ability to generate inputs using gestures with their fingers or a stylus. When two or more users would like to exchange data between their devices, it may be useful to send data from one device to another using an input gesture such as a swipe. For example, when a user wants to share a photo with another user, it may be desirable to share the photo by swiping toward the other user's device.

Additionally, when two or more devices are brought together in close proximity, it would be useful for the users to be able to utilize the combined displays on the devices. For example, it may be useful for a group of users to bring their devices together on one surface and create one large concatenated display so that a video can be rendered on a larger display composed of a number of concatenated smaller displays from individual user devices.

In the examples described above, the relative position of the user devices may be needed in order to configure a concatenated display or to allow user gestures to indicate interactions across multiple devices. For instance, when a user swipes across a screen with the intent of sending a photo to the device on the right of the user's device, the device on the right should be able to get receive the photo data from the left. Likewise, when a distributed display is formed using a group of devices, the relative positions of the screens may be needed in order to properly render the correct individual images on the appropriate device screens.

In one embodiment of this disclosure, a group of devices may be spatially ordered in terms of right, left, above, and below. It should be understood that other dimensions may be included. For example, the devices may be placed on a flat surface such as a table, and a user may swipe over the displays of the devices phones. The motion of the user's swipe may be captured and analyzed to determine the relative locations and/or orientations of the individual devices. In some embodiments, a more precise ordering of phones may be implemented up to the pixel level in order to be able to display a distributed user interface or other visual media.

In one embodiment, a group of devices may be laid next to each other in the desired order on a flat surface. A user may swipe, using a finger or stylus, over all of the devices in some order as determined by the user. In some embodiments, the devices may be running an application that may communicate to a server. Such a device may be referred to as the master device. Alternatively, one of the devices may be configured to implement the disclosed relative positioning principles. The devices may communicate with the server or master device over a local area network such as an 802.11 wireless network or a cellular network. The devices may also be time synchronized via the server or master device.

The devices may send data associated with the swiping gesture to the server or master device. The server or master device may be configured to receive the swipe information from the individual devices and determine the relative order and placement of the devices. The server or master device may also communicate the order and placement information to the devices.

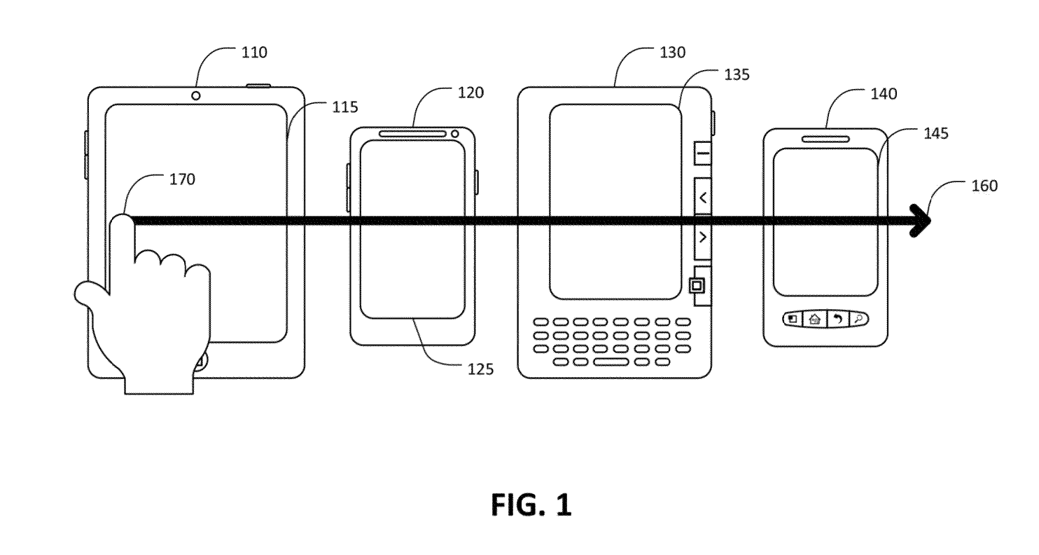

FIG. 1 illustrates an example where four devices 110, 120, 130, and 140 are placed on a surface one after another in a horizontal direction. Four devices are shown in FIG. 1 for simplicity and, for this example and the other illustrated examples herein, one skilled in the art will appreciate that there may be a different number of devices. The devices 110, 120, 130, and 140 may have associated touchscreen displays 115, 125, 135, and 145, respectively. The devices 110, 120, 130, and 140 may also be communicatively coupled to a server via a wireless network. A user may use a finger 170 to perform a swiping gesture 160 across the displays 115, 125, 135, and 14. In one embodiment, the server or master device may determine entry and exit points for the swiping gesture for each device. The server or master device may compute touch points by determining the intersection of the swipe gesture 160 with the edges of the screens.

Based on the order in which the swipe gestures were sent to the server, the server or master device can compute the relative position of the individual devices. For example, the server or master device may determine that the swiping gesture 160 entered device 120 on the left edge and exited on the right edge. The server or master device may also determine that the swiping gesture 160 entered device 130 on the left edge and exited on the right edge. The server or master device may also determine that the swiping gesture data for device 120 was received before the swiping gesture data for device 130. The server may determine that device 120 is to the right of device 130 based on the relative timing of the swiping gesture data for devices 120 and 130 and the entry/exit points of the devices 120 and 130.

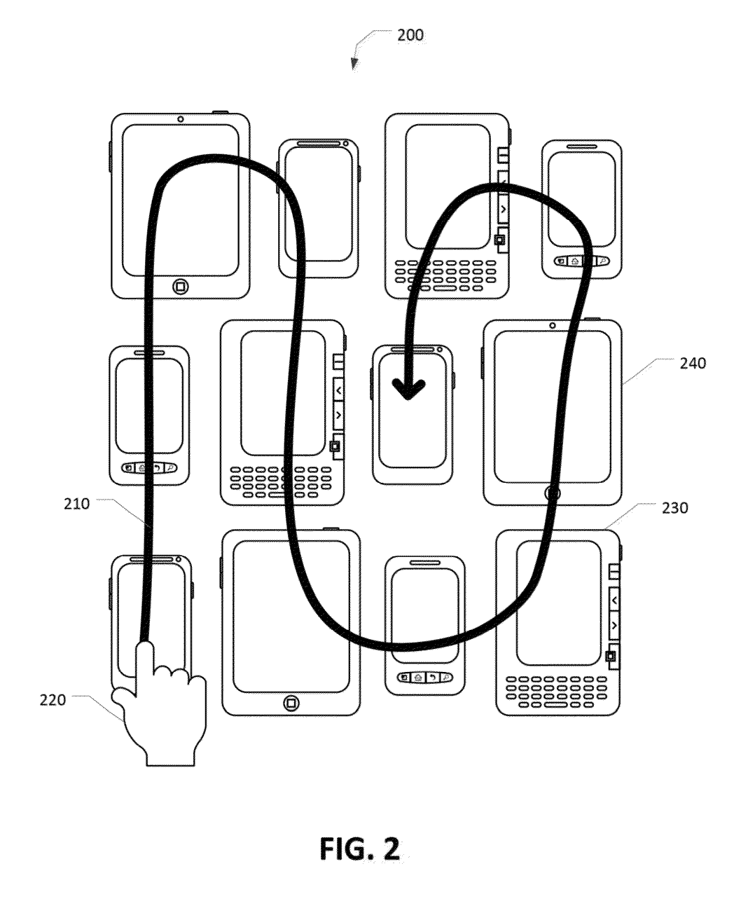

In some cases, it may be desirable to form a larger display by using the individual display screens of the individual devices. In one embodiment, the devices may be positioned to approximately form a desired larger display area as shown by devices 200 in FIG. 2. The devices 200 may include a variety of smartphones and tablets or other devices. Although the devices may be arranged into any overall shape, it may be desirable to arrange the devices in a rectangular shape and such that the devices are close to one another with little or no gaps. A user 220 may swipe across all of the devices 200 using a swiping gesture 210. In one embodiment, the server or master device may be provided the display sizes of the devices 200. The server may generate a hybrid screen composed of the screen areas of the various smartphones and tablets using the different screen sizes based on the points of touch determined by the swipe.

In one embodiment, the server or master device may determine the touch points by determining the intersection of the swipe gesture 210 with the edges of the screens. Based on the order in which the swipe gestures were sent to the server or master device, the server or master device can compute the relative position of the individual devices. For example, the server or master device may determine that the swiping gesture 210 entered device 230 on the left edge and exited on the top edge. The server or master device may also determine that the swiping gesture 210 entered device 240 on the bottom edge and exited on the top edge. The server or master device may also determine that the swiping gesture data for device 230 was received before the swiping gesture data for device 240. The server or master device may determine that device 240 is above device 230 based on the relative timing of the swiping gesture data for devices 230 and 240 and the entry/exit points of the devices 230 and 240.

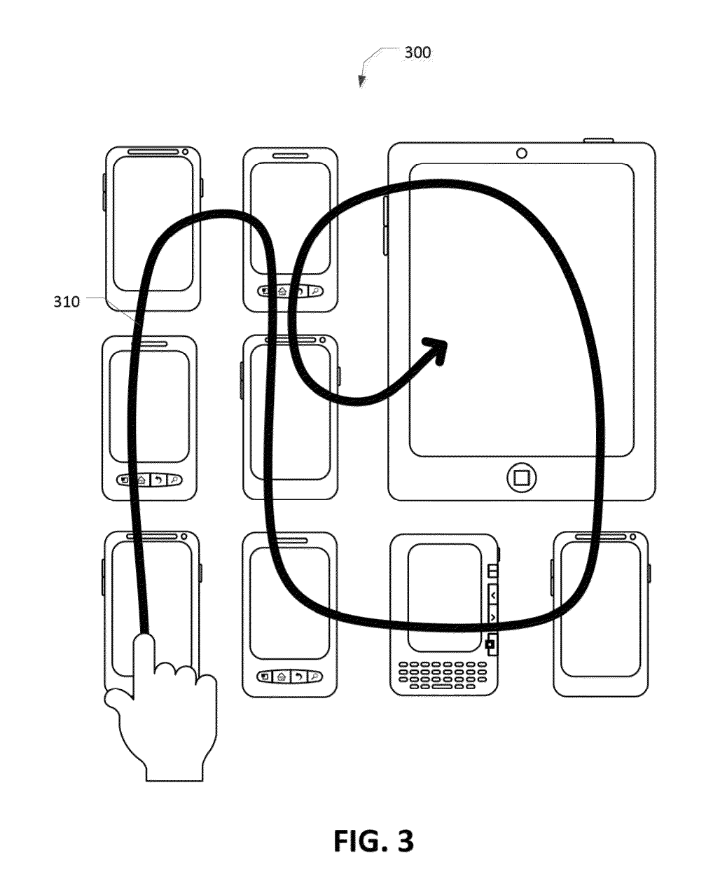

A more complicated swipe gesture may be performed, for example, in order to generate more data points. FIG. 3 depicts another example in which a swiping gesture 310 may be performed over arranged devices 300. The swiping gesture 310 may include multiple entry/exit points for some of the devices in order to provide additional data for the server or master device to determine relative positions of the devices. For example, if there are ambiguities in determining the relative position between devices, the server or master device may generate a message to the user to perform additional swiping gestures and/or by indicating which devices are not yet aligned. In one embodiment, the server or master device may cause the combined devices to generate a calibration image that indicates that the devices have been properly aligned.

After the relative positions of the devices are determined, a number of applications may be provided to the users of the devices. For example, users may share memos or photos by swiping in the direction of the device that is intended to receive the photo or video. When a larger display area is generated, the combined large display area can be used to generate a distributed user interface for gaming and other applications.

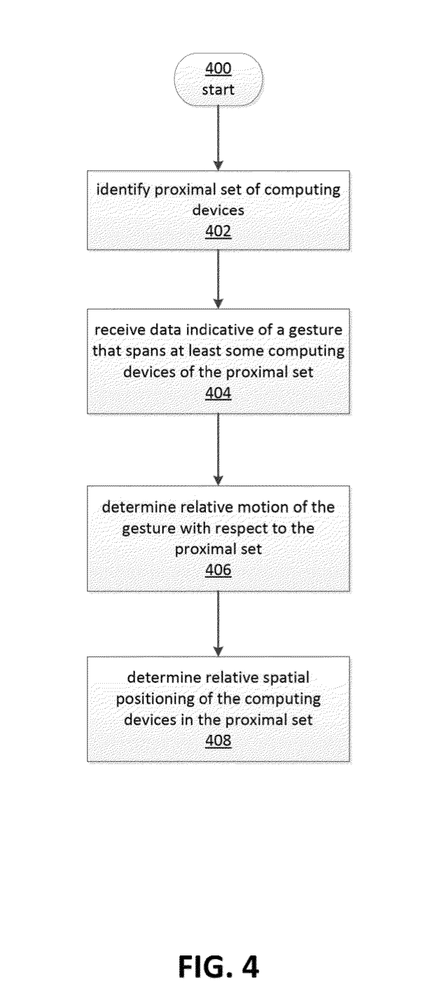

FIG. 4 illustrates an example of an operational procedure for determine relative positions of devices including operations 400, 402, 404, 406, and 408. Referring to FIG. 4, operation 400 begins the operational procedure. Operation 400 may be followed by operation 402. Operation 402 illustrates identifying a plurality of computing devices as a proximal set of computing devices.

Operation 402 may be followed by operation 404. Operation 404 illustrates receiving, from the proximal set, data indicative of a gesture that spans at least some of computing devices of the proximal set. Operation 404 may be followed by operation 406. Operation 406 illustrates determining a relative motion of the gesture with respect to the proximal set.

Operation 406 may be followed by operation 408. Operation 408 illustrates, based on the determined relative motion, determining a relative spatial positioning of the computing devices in the proximal set. In some embodiments, source and destination computing devices of the proximal set may be determined for a swiping gesture based on the determined relative spatial positioning. Additionally, data may be communicated from a first computing device of the proximal set to a second computing device of the proximal set based on the swiping gesture.

In one embodiment, the gesture data may be received from the computing devices via touchscreen input mechanisms. Alternatively, the gesture data may be received from the computing devices via imaging sensors such as a camera that is positioned to view the positioned devices and motions associated with the input gestures

In some embodiments, a composite image may be rendered using two or more of the computing devices of the proximal set based on the determined relative spatial positioning. Additionally, a multi-device application may be executed on two or more of the computing devices of the proximal set based on the determined relative spatial positioning.

In some embodiments, the relative spatial positioning of the computing devices may be determined based on input from a location determination function. The location determination function may include various systems and methods for determining the location of the computing devices. For example, the location determination function may include a satellite-based position determination system such as the Global Positioning System (GPS), position determination using base station triangulation, and Wi-Fi-based positioning.

In the disclosed detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This disclosure is generally drawn, inter alia, to methods, apparatus, systems, devices, and computer program products related to augmented reality. Briefly stated, technologies are generally described for a system for processing augmented reality data, including automatically grouping a number of augmentations into clusters referred to as exemplars and rendering the exemplars in descriptive formats.

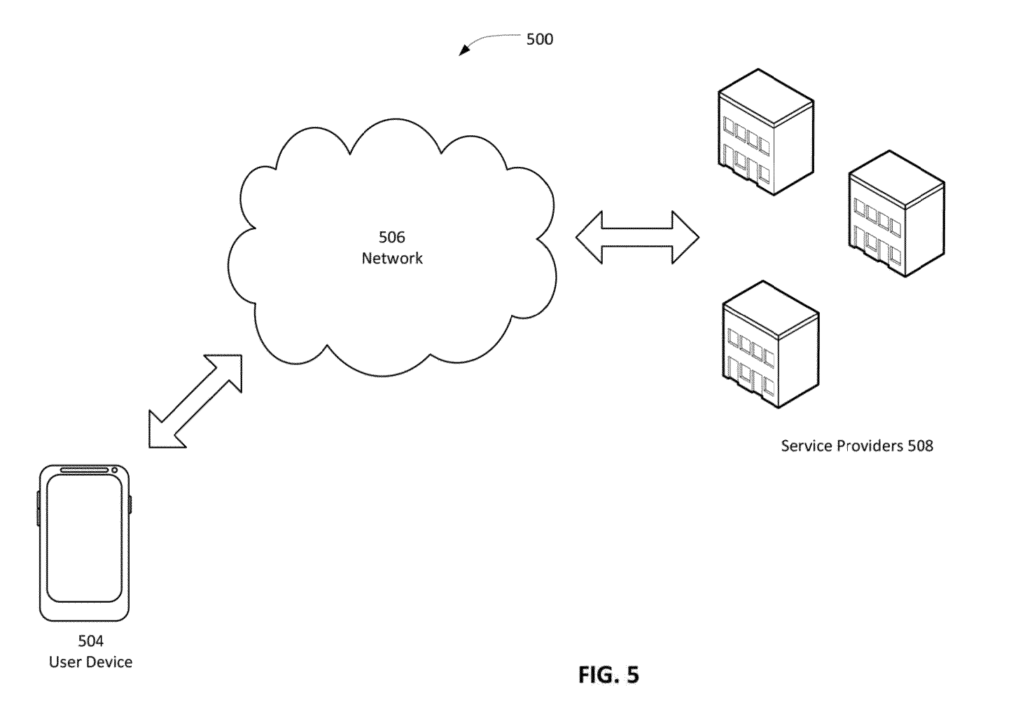

FIG. 5 depicts an example computing environment wherein aspects of the present disclosure can be implemented. In particular, FIG. 5 depicts an illustrative operating environment 500 that includes service providers 508 for providing computing resources. Service providers 508 can provide computing resources and services for executing applications and providing data services on a continuous or an as-needed basis. The computing resources and services provided by service providers 508 may include various types of resources and services, such as data processing resources, data storage resources, data communication resources, and the like.

The computing resources and services provided by service providers 508 may be enabled by one or more individual data centers that may be facilities utilized to house and operate computer systems and associated components.

The customers and other consumers of service providers 508 may access the computing resources and services provided by service providers 508 over a network 506. It should be appreciated that a local-area network (“LAN”), the Internet, or any other networking topology known in the art that connects service providers 508 to remote consumers may be utilized. It should also be appreciated that combinations of such networks might also be utilized.

A user device 504 may be a computer utilized by a customer or other consumer of service providers 508. For instance, user device 504 may be a server computer, a desktop or laptop personal computer, a thin client, a tablet computer, a wireless telephone, a personal digital assistant (“PDA”), an e-reader, a game console, or any other computing device capable of accessing service providers 508.

User device 504 may be utilized to configure aspects of the computing resources provided by service providers 508 or access services provided by service providers 508. For example, service providers 508 may provide a Web interface through which aspects of its operation may be configured or accessed through the use of a Web browser application program executing on user device 504. Alternatively, a stand-alone application program executing on user device 504 might access an application programming interface (“API”) exposed by service providers 508 for accessing the computing resources or performing the configuration operations. Other mechanisms for configuring the operation of service providers 508, including deploying updates to an application or accessing the computing resources might also be utilized.

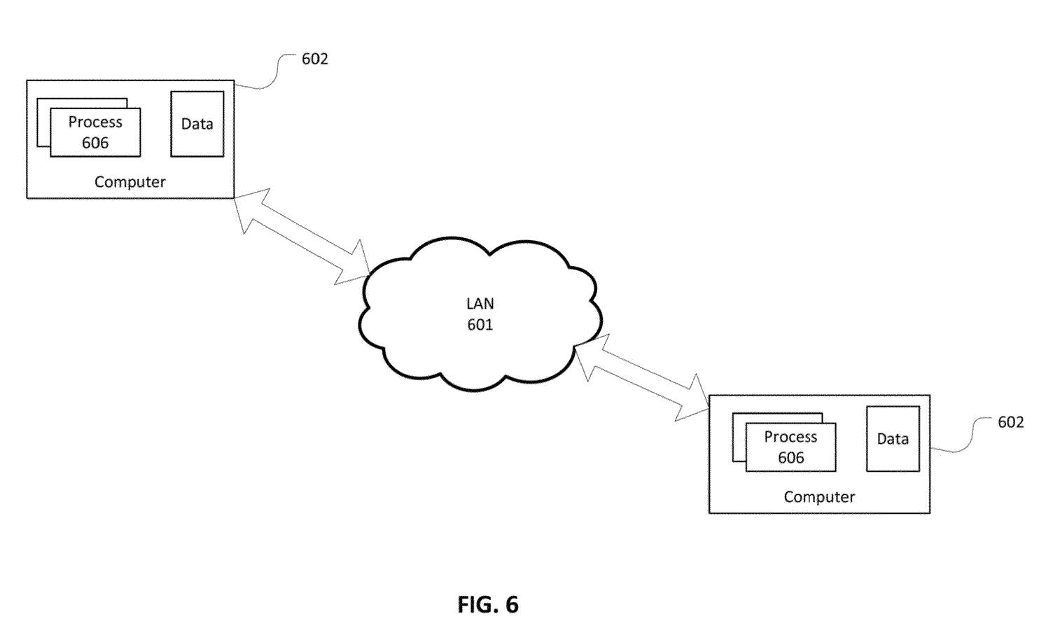

FIG. 6 depicts an example computing environment wherein aspects of the present disclosure can be implemented. As depicted, FIG. 6 shows computers 602 for executing processes 606. In the example shown in FIG. 6, a LAN 601 is utilized to interconnect computers 602. It should be appreciated that the network topology illustrated in FIG. 6 has been simplified and that many more networks and networking devices may be utilized to interconnect the various computing systems disclosed herein. These network topologies and devices should be apparent to those skilled in the art.

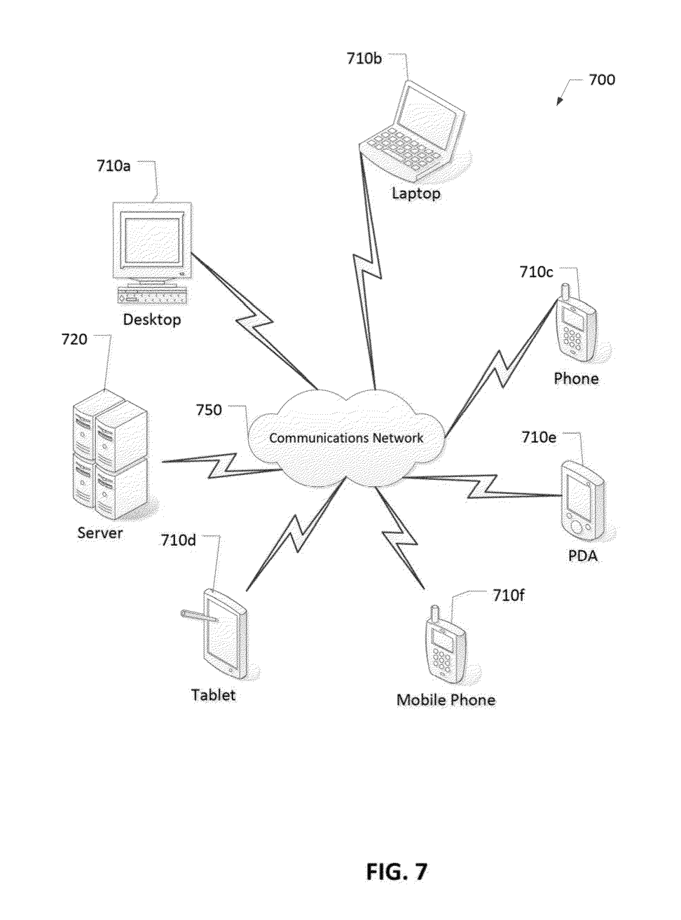

FIG. 7 depicts an example network environment in which various embodiments of the present disclosure may be implemented. In particular, FIG. 7 illustrates an example computing arrangement 700 comprised of computing devices 710 each of which may be adapted to provide positioning services as described herein. The computing devices 710 may comprise, for example, any of a desktop computer 710a, a laptop computer 710b, a phone 710c, a tablet computing device 710d, a personal digital assistant (PDA) 710e, and a mobile phone 710f, each of which may be adapted to interact with a service to provide relative positioning services.

Each of the devices 710 may be adapted to communicate using a communications network 750. The communications network 750 may be any type of network that is suitable for providing communications between the computing devices 710 and any servers 720 accessed by the computing devices 710. The communications network 750 may comprise a combination of discrete networks which may use different technologies. For example, the communications network 750 may comprise local area networks (LANs), wide area networks (WAN's), cellular networks, WiFi networks, fiber-optic networks, or combinations thereof. The communications network 750 may comprise a combination of wireless and wireline networks. In an example embodiment, the communications network 750 may comprise the Internet and may additionally comprise any networks adapted to communicate with the Internet. The communications network 750 may comprise a wireless telephony network that is adapted to communicate video, audio, and other data between the computing devices 710 and the servers 720.

In an embodiment, location and augmentation data can be processed by an augmented reality device, such as any of the computing devices 710. The augmented reality device can be coupled to an analysis engine hosted on a computing device, such as the server 720.

In an example scenario, the device 710 may be directed, for example, by a user to activate a relative positioning application. The relative positioning application may process gesture data to determine relative positions on device 710. The device 710 can communicate with the server 720 over the communications network 750. The server 720 can also include a relative positioning application. In a further scenario, the device 710 can be in communication with other computing devices 710 to exchange gesture data.

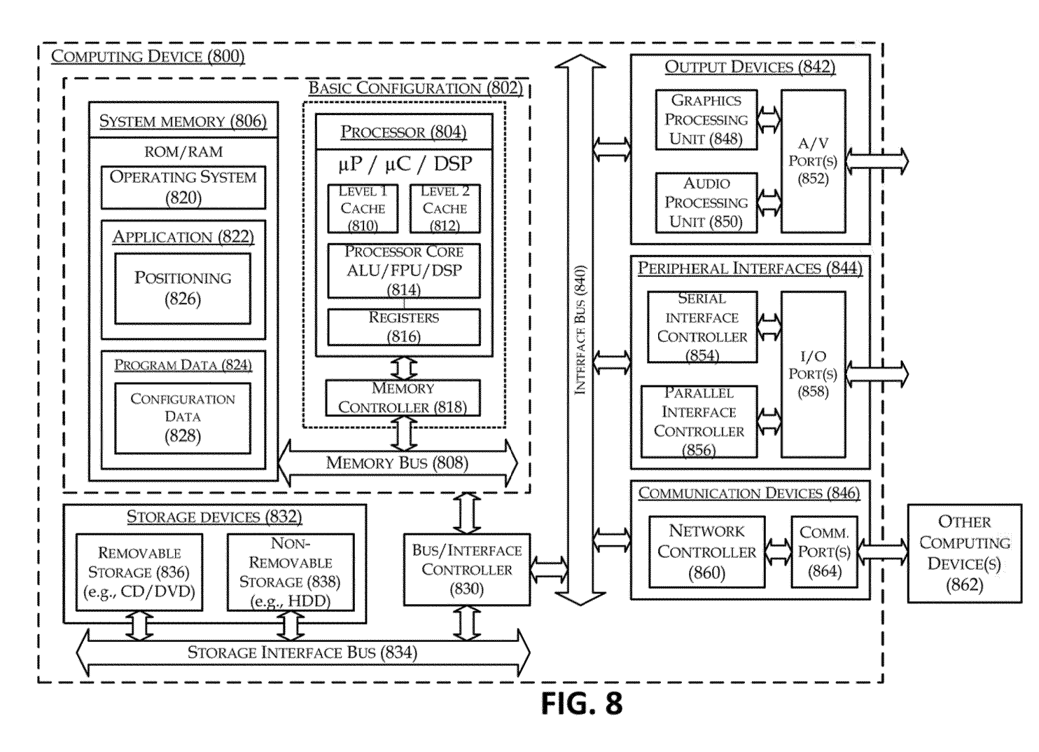

FIG. 8 depicts an example computing system wherein aspects of the present disclosure can be implemented. In particular, FIG. 8 depicts a block diagram illustrating an example computing device 800 that is arranged for determining relative positions in accordance with the present disclosure. In a very basic configuration 802, computing device 800 typically includes one or more processors 804 and a system memory 806. A memory bus 808 may be used for communicating between processor 804 and system memory 806.

Depending on the desired configuration, processor 804 may be of any type including but not limited to a microprocessor (μP), a microcontroller (μC), a digital signal processor (DSP), or any combination thereof. Processor 804 may include one more levels of caching, such as a level one cache 810 and a level two cache 812, a processor core 814, and registers 816. An example processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804.

Depending on the desired configuration, system memory 806 may be of any type including but not limited to volatile memory (such as RAM), non-volatile memory (such as ROM, flash memory, etc.) or any combination thereof. System memory 806 may include an operating system 820, one or more applications 822, and program data 824. Application 822 may include a relative positioning method 826 that is arranged to perform the functions as described herein including those described with respect to the processes described, for example, in FIGS. 1-4. Program data 824 may include configuration data 828 that may be useful for operation with the methods described above. In some embodiments, application 822 may be arranged to operate with program data 824 on operating system 820 such that that implementations may be provided as described herein. This described basic configuration 802 is illustrated in FIG. 8 by those components within the inner dashed line.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 806, removable storage devices 836 and non-removable storage devices 838 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of computing device 800.

Computing device 800 may also include an interface bus 840 for facilitating communication from various interface devices (e.g., output devices 842, peripheral interfaces 844, and communication devices 846) to basic configuration 802 via bus/interface controller 830. Example output devices 842 include a graphics processing unit 848 and an audio processing unit 850, which may be configured to communicate to various external devices such as a display Or speakers via one or more AN ports 852. Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or MOM of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 800 may be implemented as a portion of a small-form factor portable (or mobile) electronic device such as a cell phone, a personal digital assistant (PDA), a personal media player device, a wireless web-watch device, a personal headset device, an application specific device, or a hybrid device that include any of the above functions. Computing device 800 may also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically intractable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, C, etc,” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method comprising:
identifying a plurality of computing devices as a proximal set of computing devices;
receiving, from the proximal set, data indicative of a gesture that spans at least some of the computing devices of the proximal set;
determining a relative motion of the gesture with respect to the proximal set; and
based on the determined relative motion, determining a relative spatial positioning of the computing devices in the proximal set.

2. The method of claim 1, further comprising determining source and destination computing devices of the proximal set for a swiping gesture based on the determined relative spatial positioning.

3. The method of claim 2, further comprising communicating data from a first computing device of the proximal set to a second computing device of the proximal set based on the swiping gesture.

4. The method of claim 1, wherein the gesture data is received from the computing devices via touchscreen input mechanisms.

5. The method of claim 1, wherein the gesture data is received from the computing devices via imaging sensors.

6. The method of claim 1, further comprising causing rendering of a composite image using two or more of the computing devices of the proximal set based on the determined relative spatial positioning.

7. The method of claim 1, further comprising causing execution of a multi-device application on two or more of the computing devices of the proximal set based on the determined relative spatial positioning.

8. A computing device comprising at least one processor; a memory communicatively coupled to the processor, the memory having stored therein computer instructions that when executed by the at least one processor cause the computing device to:
send data to a server, the data usable to identify the computing device among a proximal set of computing devices;
send, to the server, data indicative of a gesture received via an interface of the computing device, the gesture spanning the proximal set of computing devices; and
receive data for rendering by the computing device, the received data being distributed among the computing devices of the proximal set of computing devices based on a relative spatial positioning of the computing devices in the proximal set of computing devices, the relative spatial positioning determined based on a relative motion of the gesture with respect to the proximal set of computing devices.

9. The computing device of claim 8, wherein source and destination computing devices of the proximal set for a swiping gesture are identified based on the determined relative spatial positioning.

10. The computing device of claim 9, further comprising communicating data from the computing device to another computing device of the proximal set based on the swiping gesture.

11. The computing device of claim 8, wherein the gesture data is received via a touchscreen input mechanism.

12. The computing device of claim 8, wherein the gesture data is received by the computing device via an imaging sensor.

13. The computing device of claim 8, wherein the rendered data forms a portion of a composite image.

14. The computing device of claim 8, further comprising computer instructions that upon execution by the at least one processor cause the computing device to interact with other computing devices of the proximal set based on the relative spatial positioning.

15. A system comprising a plurality of computing devices, the system comprising at least one processor; a memory communicatively coupled to the processor, the memory having stored therein computer instructions that, when executed by the at least one processor, cause the system to:
receive data indicative of an input from the plurality of computing devices;
based on the received input, determine a relative spatial positioning of each of the plurality of computing devices, the relative spatial positioning determined based on the received input; and
cause the plurality of computing devices to execute a function based on the relative spatial positioning.

16. The system of claim 15, wherein the input is indicative of an input gesture received by the plurality of computing devices.

17. The system of claim 16, wherein the input gesture is received via a touchscreen input mechanism included in each of the plurality of computing devices.

18. The system of claim 15, wherein the function is a display function operable to render a composite image using the plurality of computing devices.

19. The system of claim 15, wherein the relative spatial positioning is further determined based on input from a location determination function.

20. The system of claim 19, wherein the location determination function comprises at least one of Global Positioning System (GPS) and base station triangulation.
